(19) United States
(12) Patent Application Publication
(10) Pub. No.: US 2011/0010566 A1
(43) Pub. Date: Jan. 13, 2011

(54) POWER MANAGEMENT BY SELECTIVE AUTHORIZATION OF ELEVATED POWER STATES OF COMPUTER SYSTEM HARDWARE DEVICES

(75) Inventors: Justin P. Bandholz, Cary, NC (US); William G. Pagan, Durham, NC (US); William J. Piazza, Holly Springs, NC (US)

Correspondence Address: STREETS & STEELE - IBM CORPORATION, 13100 WORTHAM CENTER DRIVE, SUITE 245, HOUSTON, TX, 77065, US

(73) Assignee: INTERNATIONAL BUSINESS MACHINES CORPORATION, Armonk, NY (US)

(21) Appl. No.: 12/498,386

(22) Filed: Jul. 7, 2009

(51) Int. Cl. G06F 1/00

(52) U.S. Cl. 713/300

(57) ABSTRACT

Power in a computer system is managed by selectively authorizing requests by devices to operate at an elevated power state. One embodiment provides a computer system having a plurality of hardware devices interchangeably operable at mutually exclusive elevated and lower power states. The lower power states may be selected by default, and the devices independently request to operate at the elevated power state for a specified duration. A power management device, such as a baseboard management controller (BMC) or a chassis management module is configured for receiving and selectively authorizing the requests from the devices to operate at the elevated power state. The power management device subsequently revokes the authorization of the devices to operate at the elevated power state to enforce a system power limit.

### BACKGROUND OF THE INVENTION

1. Field of the Invention

The present invention relates to power management in computer systems.

2. Background of the Related Art

Modern data centers are subjected to regulations that require surplus power to be provisioned to each rack within the data center. For example, Underwriters Laboratories Inc. (UL) regulations currently require data centers to provision sufficient power to each rack equal to the sum of the maximum label power for each server installed within the rack plus a buffer of about 20%. The label power rating of each server is derived from the maximum possible power that system can draw at the most extreme configuration and workload usage scenario. In practice, servers generally operate well below their label power rating, and often in the range of only about 30% to 70% of maximum label power.

The excess power that is provisioned but not used in a datacenter is commonly referred to as “stranded power.” Stranded power can be a problem because provisioning excess power to a data center increases overhead costs, even though the excess power is never actually consumed. Although regulations governing the operation of data centers serve a well-intended purpose, the consequence of provisioning power in excess of what is actually consumed is not ideal from a power management standpoint.

### BRIEF SUMMARY OF THE INVENTION

One embodiment of the present invention provides a computer system having a plurality of hardware devices. Each hardware device is interchangeably operable at a plurality of different power states, including an elevated power state. Each hardware device is configured for independently requesting to operate at the elevated power state for a specified duration. A power management device is in electronic communication with all of the hardware devices. The power management device is configured for receiving and selectively authorizing the requests from the devices to operate at the elevated power states for the specified durations. The power management device is also configured for subsequently revoking the authorization of the devices to operate at the elevated power states upon expiration of the specified duration.

Another embodiment of the invention provides a method of managing power to a computer system. One or more devices of the computer system are operable according to a plurality of different power states including an elevated power state. Each device independently generates a request to operate at the elevated power state for a specified duration. The requests from the devices are received and selectively authorized to operate at the elevated power states for the specified durations. The authorization of the devices to operate at the elevated power states are subsequently revoked upon expiration of the specified durations.

### BRIEF DESCRIPTION OF THE SEVERAL VIEWS OF THE DRAWINGS

FIG. 1 is a generalized diagram of a computer system that may be power-managed according to one or more embodiments of the invention.

FIG. 2 is a table of example power management data for the computer system of FIG. 1 wherein the management device limits the computer system to no more than 1000 W of elevated power.

FIG. 3 is a perspective view of a rack-mountable chassis including multiple client blades whose power may be managed according to an embodiment of the invention.

FIG. 4 is a block diagram of a computer system providing an example of architecture allowing the client blades of FIG. 3 to be power managed according to an embodiment of the invention.

### DETAILED DESCRIPTION OF THE INVENTION

Embodiments of the present invention include systems and methods for reducing the maximum power utilization of a computer system by restricting the ability of the computer system's hardware devices to enter elevated power states. For example, one embodiment provides a computer system having hardware devices that are configured to generate requests to enter elevated power states, as needed. Each elevated power state request involves an associated power increase necessary to shift the hardware device from the current (lower) power state to the requested elevated (upper) power state. An elevated power state request may specify both the power increase and a duration that the device is requesting to operate at the elevated power state. The duration may be specified in terms of, for example, the number of cycles that the hardware device is requesting to operate at the elevated power state. The hardware devices may include, for example, a processor, a hard drive, a memory chip, a PCI card, a video card, an optical drive, a fan, a network adapter, a power supply, a display, or an input device.

A system management device selectively authorizes the elevated power requests in a manner that limits the maximum power utilization for the computer system. For example, the system management device may limit the total number of hardware devices that may simultaneously operate at an elevated power state. Alternatively, the system management device may selectively authorize the elevated power state requests in a manner that enforces a selected power limit. The latter scenario may be implemented, for example, by authorizing the elevated power state requests such that the sum of the power increments needed to achieve the elevated power states of devices does not exceed a predefined limit at any given moment.

After a device has operated at the elevated power state for the requested number of cycles, the system management device revokes the authorization, and the hardware device returns to a lower power state. Returning the hardware device to a lower power state liberates power that may then be used to authorize other elevated power requests. Restricting elevated power requests reduces the maximum power rating of a computer system. Reducing the maximum power rating of a computer system may reduce the amount of excess power (i.e., stranded power) required to be provisioned to a computer system. These and other aspects are covered in further detail below in connection with the accompanying figures.

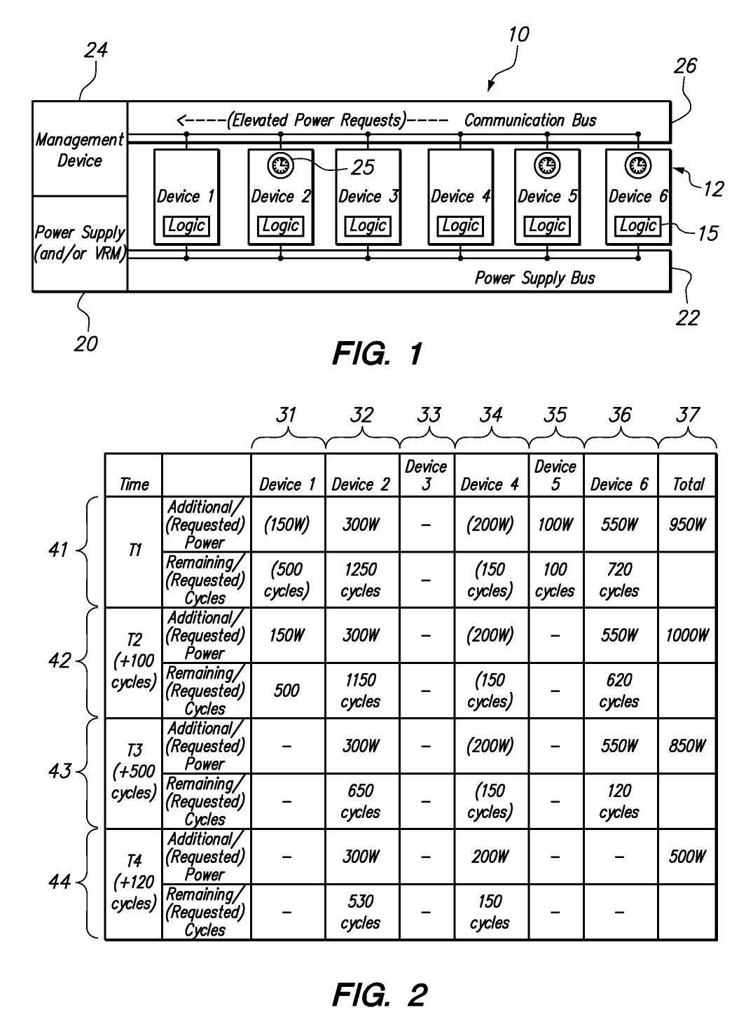

FIG. 1 is a generalized diagram of a computer system 10 that may be power-managed according to one or more embodiments of the invention. The diagram of the computer system 10 is generalized to represent a range of different computer system configurations, with further specific example configurations being provided in subsequent figures. A plurality of hardware devices 12 are individually labeled, for reference, from Device 1 to Device 6. A power supply 20 provides power to the hardware devices 12 along electronic pathways collectively referred to here as a power supply bus 22. The power supply 20 may include a voltage regulation module (VRM) for controlling the voltage to each device 12 commensurate with the power state of each device 12. The hardware devices 12 are in communication with a management device 24 along electronic pathways collectively referred to here as a communication bus 26. The hardware devices 12 draw an amount of power from the power supply 20 commensurate with the current workload on the hardware device.

Each hardware device 12 has an ability to operate at one of a plurality of different power states. Power states are commonly defined according to computer industry standards. The ACPI (Advanced Configuration and Power Interface) standard, for example, specifies one set of power states known as “power-performance” states or simply “P-states” for processors and other devices. P-states may be designated from P1 to Pn, with P0 being the highest performance state and with P1 to Pn being successively lower-performance states. The ACPI standard also specifies other states such as system state GO (working) through G3 (mechanical off), and D0 (fully-on) through D3 (off). As another example, according to such a standard, a “working” state may be considered an elevated power state relative to an “off” state.

Techniques for controlling the power state of a device in a computer system are generally known in the art under a variety of different trade names. For example, Intel SpeedStep® is a registered trademark for computer hardware, computer software, computer operating systems, and application specific integrated circuits to enable automatic transitioning between levels of voltage and frequency performance of the computer processor and computer system. Similarly, AMD PowerNow® is a registered trademark for another technology that enables automatic transitions between performance states by virtue of managing operating frequency and voltage. Such techniques of controlling frequency and/or voltage may be used to enforce a power state that has been requested and selectively authorized according to an embodiment of the invention.

The devices 12 draw an amount of power from the power supply 20 commensurate with (and limited by) the current power state. To achieve energy efficiency, the devices 12 may be configured to operate at a lower (reduced) power state during normal operation, and occasionally request an elevated power state when appropriate, such as in response to a higher workload. For example, a HDD may have multiple speeds (expressed in RPMs), including a slower speed suitable for routine tasks and a faster speed preferred for more workload-intensive tasks. The faster speed may require an elevated power state, with a corresponding power increase. As another example, a device such as a processor may operate at a lower power state (characterized by a lower operating frequency and/or voltage) during routine tasks, and occasionally request an elevated power state for more workload-intensive tasks. For example, a device to be power-managed could be operated by default in a maximally throttled state corresponding to the low end of a range of power consumption. In response to the device requesting a higher power state, the device could be placed in a less-throttled state corresponding to a higher level of power consumption, or even a fully-powered state corresponding to the upper end of the range of power consumption.

Each device 12 intermittently needs to change from a lower power state, where it may be operating by default, to an elevated power state, such as in response to an increased power demand on the particular device 12. For example, a HDD may normally operate at a lower speed corresponding to a lower power state when idling, and request an elevated power state corresponding to a higher RPM during a boot-up procedure or other more workload-intensive task. In another example, a CPU executing a database application may normally operate at a lower power state during a data compiling phase, and request to operate at an elevated power state during a computationally-intensive phase of executing a database query on the compiled data.

Elevated power requests could also be managed by prioritizing the elevated power requests. For example, a fan may need to enter an elevated power state to handle an elevated temperature scenario, which would take precedence over less urgent elevated power requests. The prioritization could be implemented by the management device as part of policy settings known to the management device. Alternatively, each elevated power request may specify a priority level as another parameter of the elevated power request.

The devices 12 require authorization by the management device 24 in order to enter an elevated power state. To operate at an elevated power state, each device 12 must individually generate an electronic request to operate at the elevated power state. Each device 12 includes a logic module 15 which may include a combination of circuitry and program code allowing the device 12 to independently generate the elevated power state request. The elevated power state requests generated by the devices 12 are communicated along the communication bus 26 to the management device 24. Each elevated power state request may include an elevated power increment and a requested duration. The elevated power increment may indicate how much additional power (relative to the power required at the present lower power state) or how much total power the requesting device 12 will need to operate at the elevated power state. The requested duration may be expressed in terms of, for example, a number of clock cycles or as a time period for which the requesting device 12 desires to operate at the elevated power state. The management device 24 receives the elevated power state requests, selectively authorizes the elevated power state requests, and subsequently revokes the elevated power state requests, to manage the power consumption of the computer system 10.

The computer system 10 of FIG. 1 is shown at an instant in time, wherein Devices 2, 5, and 6 are currently operating at an elevated power state under authorization of the management device 24. A timer icon 25 above Device 2, Device 5, and Device 6 indicates that the elevated power state for each of these devices 12 has being authorized for the duration requested by the respective device 12. At the expiration of the requested duration, the management device 24 will revoke the authorization for the elevated power state request for that device 12. Upon revocation of the elevated power state request, the respective device 12 returns to a lower power state. By default, any of the devices 12 may be shifted to the power state at which the device 12 was operating prior to authorization of the elevated power request, or another lower power state may be requested by the device 12.

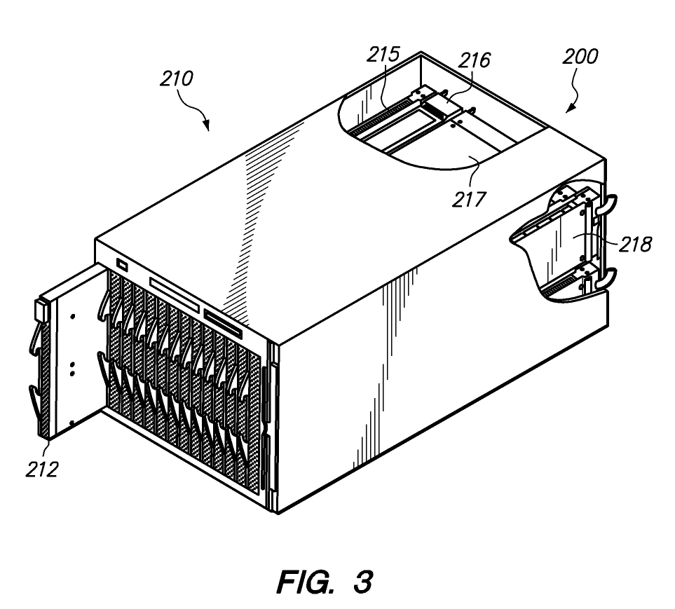

FIG. 2 is a table of example power management data for the computer system of FIG. 1 wherein the management device limits the computer system to no more than 1000 W of elevated power at any given moment. The power management data includes power and duration values in columns 31 through 36 associated with elevated power requests made by Device 1 through Device 6. The requested elevated power increments are listed in Watts (W), and the requested duration values are listed in clock cycles. The requested power and duration values are indicated at four different times T1 to T4 in rows 41 through 44. Times T1 to T4 are provided by example and not at uniformly-spaced time intervals. Time T2 occurs 100 clock cycles after Time T1, Time T3 occurs 500 cycles after Time T2, and Time T4 occurs 120 cycles after Time T3. Requested power and duration values that have not yet been authorized are listed parenthetically; requested power and duration values that have been authorized are listed without parentheses.

The elevated power increments are expressed here as the difference between power consumed by a device at the elevated power state and the power consumed by the same device at the previous (lower) power state. For example, the table indicates that at Time T1, Device 1 is requesting to operate at an elevated power increment of 150 W, i.e. at an elevated power state that is 150 W higher than at the previous (lower) power state. The elevated (upper) and lower power states may be separated by any two power values that are 150 W apart, such as an elevated power state of 1250 W and a lower power state of 100 W, or an elevated power state of 500 W and a lower power state of 350 W.

The table of FIG. 2 serves as an example of enforcing a hypothetical power limit of 1000 W. Power to the devices is managed so that the sum of the elevated power increments currently authorized by the management device does not exceed 1000 W at any given instant. For example, at Time T1, Devices 2, 5, and 6 are currently operating at elevated power states of 300 W, 100 W, and 550 W above the previous (lower) power states. The power increments total 950 W at T1 (see column 37), which is 50 W less than the system power limit of 1000 W. At Time T1, an elevated power state request is pending for each of Device 1 and Device 4, as parenthetically indicated. This indicates that Device 1 (column 31) has requested to operate at an elevated power state of 150 W above the lower power state of Device 1 for a duration of 500 cycles, and Device 4 (column 34) has requested to operate at an elevated power state of 200 W for 150 cycles. Neither elevated power state request can be authorized at Time T1 without exceeding the 1000 W limit; thus, the elevated power state requests of Devices 1 and 4 remain pending at Time T1.

Time T2 occurs 100 clock cycles after Time T2, upon revocation of the elevated power request for Device 5. Revocation of the elevated power state request of Device 5 at that instant liberates an additional 100 W, which, in addition to the 50 W power margin already available at T1, provides enough power (150 W) to authorize the elevated power state request of Device 1 that had been pending prior to time T2. Thus, at time T2 (row 42), Device 1 begins operating at its elevated power state (having a power increment of 150 W), and Devices 2 and 6 continue operating at their elevated power states (300 W and 550 W power increments) for the remaining number of cycles indicated in columns 32 and 36, for a total power increment of 1000 W (150 W+300 W+550 W). The elevated power state request of Device 4 is still pending, since the request of an additional 200 W cannot be authorized without exceeding the 1000 W power limit at Time T2.

Time T3 occurs 500 cycles after Time T2, upon revocation of the 150 W elevated power state request of Device 1. Devices 2 and 6 are still operating at power increments of 300 W and 550 W, respectively, for a total of 850 W, leaving 150 W of available power relative to the 1000 W power limit. Device 2 has 650 cycles remaining and Device 6 has 120 clock cycles remaining their currently authorized elevated power state requests. The elevated power state request of Device 4 remains pending, since the 200 W power increment still cannot be authorized without exceeding the 1000 W power limit.

Time T4 occurs 120 cycles after Time T3, upon revocation of the 550 W elevated power state request of Device 6. The revocation of the 550 W elevated power state request of Device 6 liberates enough power relative to the 1000 W system power limit to authorize the 200 W elevated power state request of Device 4. Thus, Device 2 and Device 4 are now operating at their elevated power states, for a total elevated power of 500 W. No other elevated power state requests are pending and no new elevated power state requests have been made at Time T4.

The power management data in the table of FIG. 2 is provided merely as an example to illustrate the selective authorization of elevated power state requests made by various devices in a computer system to enforce a system power limit. While the table includes four Times, T1 through T4, and power management data for six devices, it should be recognized that a very large number of elevated power state requests may be managed in a short period of time due to the high clock rates in modern computer systems.

In computer systems, the number of processes to be executed at any given moment may easily exceed the number of CPUs available to run the processes. Scheduling techniques are known in the art for assigning processes to run on a limited number of CPUs. For example, various techniques are known in the art for concurrent or simultaneous execution of multiple processes on a limited number of processors and other devices.

One embodiment of the invention provides a power management method incorporating modern task scheduling techniques to fairly allocate time for devices to be in an elevated power state for specified durations. For example, a scheduling method may include steps for identifying the various tasks that make up each process and to determine which tasks will require invoking an elevated power state of the CPU or other device involved in execution of each task. The method may include steps for selectively authorizing those tasks requiring an elevated power state, such as to limit the number of devices operating at an elevated power state or to limit the additional power allocated for operating devices at elevated power states. Tasks to be scheduled may be evaluated to determine which tasks will involve an elevated power state request from a hardware device. A task scheduler, such as a software object or application, may schedule the execution of the tasks involving elevated power state requests in a manner calculated to enforce the system power limit or to limit the number of devices concurrently operating at elevated power states.

The above example using the power management data of FIG. 2 assumes that each elevated power state request, once authorized, is allowed to continue uninterrupted for the requested duration. However, instances may arise wherein the system management device revokes authorization of an elevated power state request at least temporarily. Certain events or tasks to be performed may warrant overriding any current processes, such that an authorization may be temporarily revoked prior to the full duration specified in the elevated power state request. For example, a system alarm indicating an abnormal system condition, such as a dangerously high temperature, may cause certain processes to be suspended, so that measures may be taken to correct the alarm event. When the alarm event has passed, the management device may re-authorize any elevated power state requests for the remainder of the request duration.

FIG. 3 is a perspective view of a rack-mountable chassis 210 including multiple blades 212, wherein power to the blades 212 may be managed according to an embodiment of the invention. The chassis 210 has, by way of example, fourteen bays for receiving fourteen blades 212. The blades 212 may include networked server blades, workstation blades, or other modular computers or components having a blade form factor. Each blade 212 may act as a network node. The blades 212 share system resources such as power, cooling, and network connectivity provided by various support modules in the chassis 210. The support modules include a chassis management module 215, a power supply module 216, a fan assembly 217, and a network switch module 218. The chassis management module 215 manages the chassis 210, servers 212, and the other modules within the chassis. The power module 216 provides electrical power to all of the servers 212. The fan assembly 217 generates airflow through the chassis 210 to remove the heat generated by the servers 212 and support modules. The switch module 218 provides network connectivity between the blade server I/O and the network. The servers 212 and support modules 215-218 are interconnected within the chassis 210 to provide power and data signal communication. The servers 212 and support modules may interconnect, for example, at an internal chassis interface known as the midplane, which has rigid connectors for docking the blade servers 212 and support modules. Cable connections may also be made within the chassis 210, although the midplane may reduce or eliminate cabling requirements.

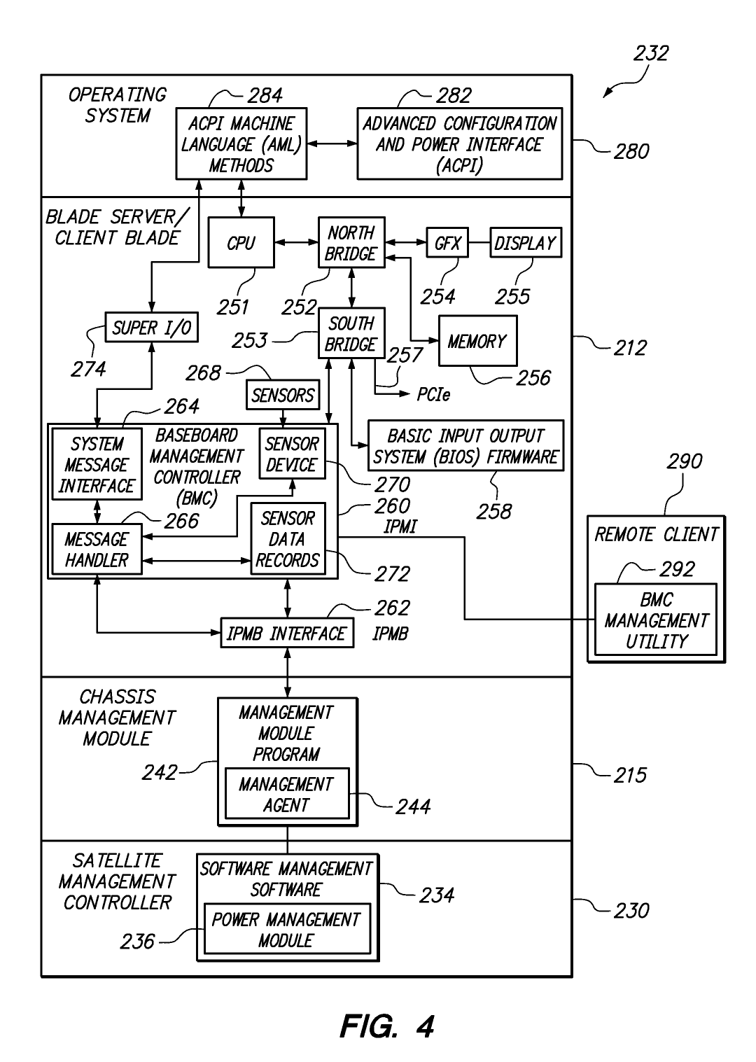

FIG. 4 is a block diagram of a computer system 232 providing an example of architecture allowing the client blades 212 of FIG. 3 to be power managed according to an embodiment of the invention. The computer system 232 includes the chassis management module 215, an optional remote management controller 230, one of the client blades (e.g. blade server or workstation blade) 212 running an operating system 280, and an optional remote client 290. Only one client blade 212 is shown, for purpose of discussion, although power to multiple client blades may be managed. Either or both of the remote management controller 230 and the chassis management module 215 may act as components of the generalized management device 24 of FIG. 1. The remote management controller 230 may be a stand-alone computer console running system management software (SMS) 234, such as IBM DIRECTOR, including a power management module 236, such as IBM POWEREXECUTIVE (IBM, DIRECTOR, and POWEREXECUTIVE are trademarks of International Business Machines Corporation of Armonk, N.Y.). The remote management controller 230 may be located within or outside a datacenter in which the chassis 210 is located and may communicate with the chassis management module 215 of the chassis 210 (See FIG. 3) over an Ethernet connection. The chassis management module 215 runs a management module program 242, including a management agent 244 for interfacing with the system management software 234.

According to an embodiment of the present invention, a power management method may be implemented by software running within the remote management controller 230, the chassis management module 215, the baseboard management controller 260, or some combination thereof. Although not required, a feature of managing power consumption from the remote management controller 230 is the ability to manage power to multiple chassis from a single remote location. When the remote management controller 230 is used to implement the power management method, the remote management controller 230 may manage the elevated power state requests from hardware devices or groups of hardware devices included with each server within the chassis. Alternatively, the chassis management module 215 in each chassis may manage the elevated power state requests of each server within the respective chassis, or dictate to the baseboard management controller 260 how to management the elevated power state requests.

The chassis management module 215 is in communication with each client blade 212 within the chassis 210. The client blade 212 includes a hardware configuration, including, without limitation, a CPU 251, a north bridge 252, a south bridge 253, a graphics card 254, video output 255, RAM memory 256, a Peripheral Component Interconnect Bus (PCIe) bus 257, and Basic Input/Output system (BIOS) 258. Other components and details of a typical client blade will be known to those having skill in the art.

The client blade 212 also includes what is generally known in the art as Intelligent Platform Management. A baseboard management controller (BMC) 260 provides the intelligence behind Intelligent Platform Management, and manages the interface between system management software 234, client blade hardware 251-58, and the operating system 280. The BMC 260 includes an Intelligent Platform Management Interface (IPMB) 262 for communicating with the chassis management module 215 and a System Message Interface (SMI) 264 for communicating with the operating system 280. A message handler 266 of the BMC handles IMPI messages to and from these interfaces. The BMC 260 may also be in communication with various sensors 268 within the client blade 212, such as a CPU temperature sensor and a power supply output gauge. The sensors 268 communicate with a sensor device 270 for discovering, configuring and accessing sensors. Sensor data 272 is then reported to the Message Handler 266 logging in the sensor data records. Upon receiving a request for sensor data from the system management software 234 or the chassis management module 215, the Message Handler 266 retrieves and sends out the sensor data via the IPMB Interface 262.

The operating system 280 may include typical operating system components, including an Advanced Configuration and Power Interface (ACPI) 282. The ACPI 282 uses its own ACPI Machine Language (AML) 284 for implementing a power event handler or AML method. The AML method 284 receives instructions from the BMC 260 through the system message interface 264 and the general purpose I/O ports of a Super I/O 274. The AML method 284 changes the state of the CPU 251, in accordance with the instructions, and may send messages back to the BMC confirming the new ACPI state of the CPU 251.

In accordance with the embodiment of FIG. 4, a management device, including the remote management controller 230 and/or chassis management module 215, may implement the power management method by sending IPMI messages that instruct the operating system to control the ACPI state of the processor(s) or other hardware devices in a client blade and sending IPMI messages that instruct the operating system to control the speed step of the processor(s). This functionality allows the remote management controller 230 and/or chassis management module 215 to selectively authorize elevated power states requested by various devices, as described in relation to the generalized system diagram of FIG. 1 and the example table of FIG. 2. Upon receiving and authorizing an elevated power state request, the management entity may thereby authorize elevation of the power state of the authorized device. For example, the management device may switch one or more processors from a sleep state to a working state, or increase the speed step of an already working processor to a higher power state.

In embodiments where the client blade 212 is a thin client, the remote client 290 may provide a user interface for an individual user to interface with the client blade 212, and the operating system, applications, data storage, and processing capability reside on the client blade 212. In that case, the remote client 290 may send and receive data with the client blade 212 via an Ethernet network. The remote client 290 may also include a BMC Management Utility 292 and utilizes IPMI Over LAN communications with the BMC 260.

Devices that are to be power limited because of higher power consumption elsewhere in the system may also have their power consumption reduced by, for example, being clock or voltage throttled, having wait states imposed, having power management registers reconfigured, etc. In an alternative embodiment, the BMC 260 may detect that a device is entering a higher power consumption state without advance notification (for example, by monitoring power consumption of individual subsystems). In response to sensing this higher power consumption, the BMC 260 may direct other subsystems to avoid entering high power modes of operation.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible storage medium having computer-usable program code stored on the storage medium.

Any combination of one or more computer usable or computer readable storage medium(s) may be utilized. The computer-usable or computer-readable storage medium may be, for example but not limited to, an electronic, magnetic, electromagnetic, or semiconductor apparatus or device. More specific examples (a non-exhaustive list) of the computer-readable medium include: a portable computer diskette, a hard disk, random access memory (RAM), read-only memory (ROM), an erasable programmable read-only memory (EPROM or Flash memory), a portable compact disc read-only memory (CD-ROM), an optical storage device, or a magnetic storage device. The computer-usable or computer-readable storage medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer-usable or computer-readable storage medium may be any storage medium that can contain or store the program for use by a computer. Computer usable program code contained on the computer-usable storage medium may be communicated by a propagated data signal, either in baseband or as part of a carrier wave. The computer usable program code may be transmitted from one storage medium to another storage medium using any appropriate transmission medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer system, comprising:
a plurality of hardware devices, each hardware device interchangeably operable at a plurality of different power states including an elevated power state, each hardware device configured for independently requesting to operate at the elevated power state for a specified duration; and
a power management device in electronic communication with all of the hardware devices, the power management device configured for receiving and selectively authorizing the requests from the devices to operate at the elevated power states for the specified durations, and subsequently revoking the authorization of the devices to operate at the elevated power states upon expiration of the specified duration.

2. The computer system of claim 1, wherein the power management device is configured to limit the number of devices that may simultaneously operate at the elevated power states to fewer than all of the plurality of devices.

3. The computer system of claim 1, wherein the power management device is configured to authorize the elevated power state requests such that the additional power needed to achieve the elevated power states of devices does not exceed a predefined limit.

4. The computer system of claim 1, further comprising a motherboard, wherein the hardware devices include components of the motherboard and wherein the power management device comprises a baseboard management controller included with the motherboard and in electronic communication with the plurality of components of the motherboard.

5. The computer system of claim 1, wherein the hardware devices include one or more of the group consisting of a processor, a hard drive, a memory chip, a PCI card, a video card, an optical drive, a fan, a network adapter, a power supply, a display, and an input device.

6. The computer system of claim 1, further comprising:
a multi-blade chassis having a plurality of bays;
a plurality of client blades, each client blade receive in one of the bays, and each client blade including one or more of the hardware devices; and
wherein the power management device comprises a chassis management module in the chassis for managing power to the plurality of client blades.

7. The computer system of claim 1, further comprising a voltage regulation module in communication with the chassis management module, the voltage regulation module configured to vary the voltage to the devices according to the power states of the devices.

8. A method of managing power to a computer system, comprising:
operating one or more devices of the computer system, each device having a plurality of different power states including an elevated power state;
independently generating a request by each device to operate at the elevated power state for a specified duration;
receiving and selectively authorizing the requests from the devices to operate at the elevated power states for the specified durations; and
subsequently revoking the authorization of the devices to operate at the elevated power states upon expiration of the specified durations.

9. The method of claim 8, further comprising limiting the number of devices that may simultaneously operate at the elevated power states to fewer than all of the devices.

10. The method of claim 9, further comprising authorizing the elevated power state requests such that the additional power needed to achieve the elevated power states of the devices does not exceed a predefined limit.

11. The method of claim 9, wherein increasing the power state of a device comprises increasing one or both of the operating frequency and the voltage of the device.

12. A computer program product including computer usable program code embodied on a computer usable medium for managing power to a computer system, the computer program product including:
computer usable program code for operating one or more devices of the computer system, each device having a plurality of different power states including an elevated power state;
computer usable program code for independently generating a request by each device to operate at the elevated power state for a specified duration;
computer usable program code for receiving and selectively authorizing the requests from the devices to operate at the elevated power states for the specified durations; and
computer usable program code for subsequently revoking the authorization of the devices to operate at the elevated power states upon expiration of the specified durations;

13. The computer program product of claim 12, further comprising:
computer usable program code for limiting the number of devices that may simultaneously operate at the elevated power states to fewer than all of the devices.

14. The computer program product of claim 12, further comprising:
computer usable program code for authorizing the elevated power state requests such that the additional power needed to achieve the elevated power states of the devices does not exceed a predefined limit.

15. The computer program product of claim 12, further comprising:
computer usable program code for increasing the power state of a device by increasing one or both of an operating frequency and a voltage of the device.
